(19) United States
(12) Patent Application Publication
(10) Pub. No.: US 2026/0072916 A1
(43) Pub. Date: Mar. 12, 2026

(54) K-NEAREST NEIGHBOR GRAPH DETERMINATION

(71) Applicant: GSI Technology Inc., Sunnyvale, CA (US)

(72) Inventor: Avidan AKERIB, Tel Aviv (IL)

(21) Appl. No.: 19/390,718

(22) Filed: Nov. 17, 2025

Related U.S. Application Data
(63) Continuation of application No. 17/735,139, filed on May 3, 2022, now Pat. No. 12,488,002.
(60) Provisional application No. 63/334,216, filed on Apr. 25, 2022.
(60) Provisional application No. 63/192,032, filed on May 23, 2021.

(51) Int. Cl. G06F 16/2455; G06F 16/22

(52) U.S. Cl. CPC G06F 16/24553; G06F 16/2264

(57) ABSTRACT

A method for determining a K-Nearest Neighbor (KNN) graph for a dataset of full dimension vectors includes, for each record in a database of full dimension vectors, performing a K-Nearest Neighbor (KNN) search to locate W nearest neighbors of the record; and updating a KNN graph to include an index of the record and W indices of the W nearest neighbors located for the record. The updating includes creating a first node for the record, the first node comprising an index of the record, and creating W second-level nodes, each second-level node comprising an index of one of the W nearest neighbors.

### CROSS REFERENCE TO RELATED APPLICATIONS

This application is a continuation application of US 17/735,139, filed May 3, 2022, which claims priority from US provisional patent application 63/192,032, filed May 23, 2021, and US provisional patent application 63/334,216, filed April 25, 2022, all of which are incorporated herein by reference.

### FIELD OF THE INVENTION

The present invention relates to associative memory generally and to a method for using a KNN graph in conjunction with an APU to provide fast and accurate K nearest neighbors.

### BACKGROUND OF THE INVENTION

An object (such as picture, text, music etc.) may be semantically represented in a dataset by a full dimension feature vector of numbers. The object raw data is represented by numerical features, also called feature embeddings, which can be processed while preserving the information of the original object.

The feature vector may be obtained by using a neural network that receives the object as input and provides as output a full dimension feature vector (e.g., 128K x 1024 words). Feature vectors can be compared using the K nearest neighbors (KNN) algorithm known in the art and various applications use the KNN search algorithm to find K (e.g., 25) objects (from a large dataset) that most closely resemble a query object. Such applications include face recognition, image recognition, document and text search, music recognition and the like.

The applications can store the large dataset of M feature vectors (M may be several millions) in an Associative Processing Unit (APU), such as the Gemini Associative Processing Unit of GSI Technology Inc. of the USA, where the KNN search algorithm is very fast and performed in a constant complexity irrespective of the size of the dataset. The KNN implementation on Gemini is described in US patent 10,929,751, assigned to Applicant and incorporated herein by reference. Storing the full dimension vectors in the APU utilizes a lot of memory. When the associative memory of the APU is not large enough to contain the entire dataset of feature vectors, the entire dataset is stored in the memory of a host device which copies different parts of the dataset at a time to the associative memory for processing.

It is possible to improve the performance and memory utilization of the KNN search algorithm by reducing the dimensions of the feature vectors (e.g., to 512 – 2000 bits). A reduced dimension vector of each element may be created (by methods such as Neural Proxy Hash (NPH) or Local Sensitivity Hashing (LSH)) and stored in the APU instead of the full dimension feature vector that may be stored in the host. Performing a KNN search using reduced dimension vectors is faster than a KNN search performed on the full dimension feature vectors since the APU is very efficient in performing binary operations, such as Hamming distance, L1, L2, Tanimoto similarity search and the like, compared to operating on full floating-point MAC performed on a GPU or a CPU.

It may be noted that smaller vectors imply faster search and less memory utilization in the APU. On the other hand, smaller vectors produce less accurate results since each reduced dimension vector contains less information.

To maintain the required accuracy when working with reduced dimension vectors, the KNN search algorithm returns a larger number, Krdv, of reduced dimension neighboring vectors (e.g., 4000) compared to the number original number K (e.g., 25) of full dimension neighboring vectors when working with the full dimension vectors. It may be noted that Krdv is much larger than K.

In addition, a final re-ranking step should be performed in the host to search the final 25 full dimension feature vectors (out of the 4000 that were found using the reduced dimension vectors) that are the nearest neighbors of the query vector. In this step, the host should retrieve the full dimension vectors (associated with a larger number Krdv of reduced dimension vectors) from the database and perform a second KNN search operation between the full dimension vector of the query object and the larger number Krdv of full dimension vectors to find the final original number K of nearest neighbors.

FIG. 1, to which reference is now made, is a schematic illustration of a prior art system 10 that receives as input a full dimension query vector 11 and provides as output a list 18 of its K nearest full dimension neighbor vectors. System 10 comprises a host 15 connected to an APU 12 and to a database 16 storing a large dataset of full dimension vectors. APU 12 comprises an associative memory array 13 storing a large dataset of records. Each record in memory array 13 includes an index and a reduced dimension vector associated with a full dimension vector in database 16.

Host 15 passes a full dimension query vector 11 to APU 12 that reduces its dimension and performs a first KNN search algorithm on database 16 to find a list of the Krdv nearest neighbors of query vector 11 (note that the KNN is performed on reduced dimension vectors). Host 15 uses a CPU or a GPU for a final re-rank step to provide the final K nearest neighbors out of the Krdv vectors found by APU 12.

FIG. 2, to which reference is now made, is a schematic illustration of a flow that may be implemented by system 10. The input to the flow is the full dimension query vector 11. System 10 may, in step 22, reduce the dimension of full dimension query vector 11 and, in step 24, activate a first KNN search algorithm to find a relatively large number Krdv of reduced dimension nearest neighbors and provide their indexes in database 16. System 10 may perform step 22 and step 24 in APU 13 (FIG. 1) and provide the indexes to host 15 that may proceed with the next steps. In step 26 host 15 may fetch the Krdv full dimension vectors from database 16 and in step 28 activate a second KNN search algorithm to re-rank the results and find the final K full dimension nearest neighbor and provide them as output 18.

It may be noted that, if the dimension should be further reduced (to save memory in APU 12), the number of objects Krdv that is needed to be found by the first KNN search operation in APU 12 should be increased in order to keep the needed accuracy and to perform the re-rank operation on host 15 with a higher number of vectors, since the lower accuracy provided by the reduced dimension vectors may be compensated by increasing their number.

The search in APU 12 is very fast and is performed in a constant complexity regardless of the size of the dataset, but the Input/Output (IO) operation needed to be performed by host 15 for the final re-rank operation becomes slower as the number of indexes that should be returned is increased. When operating with reduced dimension vectors, the host needs to retrieve a relatively large number of indexes which reduces the performance of the overall operation.

### SUMMARY OF THE PRESENT INVENTION

There is therefore provided, in accordance with a preferred embodiment of the present invention, a method for determining a K-Nearest Neighbor (KNN) graph for a dataset of full dimension vectors. The method includes, for each record in a database of full dimension vectors,

performing a K-Nearest Neighbor (KNN) search to locate W nearest neighbors of the record, and updating a KNN graph to include an index of the record and W indices of the W nearest neighbors located for the record. The updating includes creating a first node for the record, the first node comprising an index of the record, and creating W second-level nodes, each second-level node comprising an index of one of the W nearest neighbors.

There is also provided, in accordance with a preferred embodiment of the present invention, a KNN graph stored in a memory. The KNN graph includes a plurality of first-level nodes, each first-level node corresponding to an item in a dataset. Each first-level node includes an index to a full dimension vector of the corresponding item, a plurality of second-level nodes; and W pointers from a first-level node to a plurality of second-level nodes. Each second-level node includes an index to a full dimension vector that is a neighbor of the item corresponding to the first-level node from which the second-level node is pointed.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for finding the K nearest full dimension neighbor vectors of a full dimension query vector, known in the art;

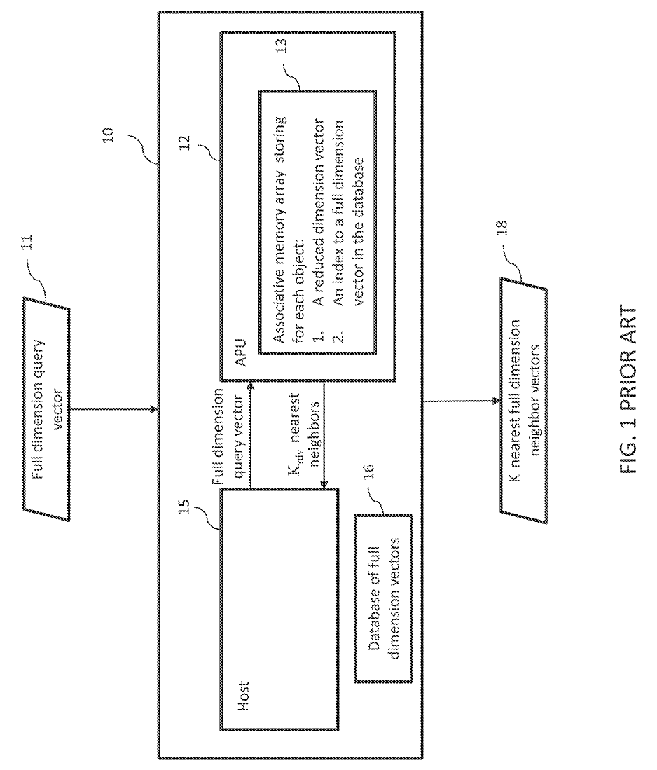

FIG. 2 is a schematic illustration of a flow that may be implemented by the system of FIG. 1.

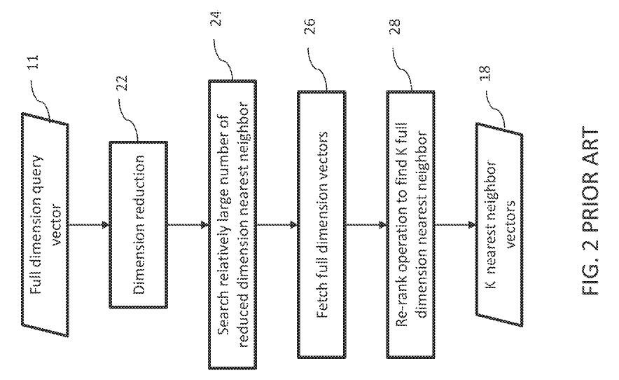

FIG. 3 is a schematic illustration of the structure of a KNN graph, in accordance with an embodiment of the present invention;

FIG. 4 is a schematic illustration of a flow used to build the KNN graph of FIG. 3, in accordance with an embodiment of the present invention;

FIG. 5 is a schematic illustration of an associative graph search system, constructed and operative in accordance with a preferred embodiment of the present invention that uses the KNN graph of FIG. 3 for expanding the number of nearest neighbors without impairing the performance; and

FIG. 6 is a schematic illustration of a flow that may be implemented by the associative graph search system of FIG. 5 in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that the number of neighbors that need to be found by the first KNN search operation may be reduced by pre-calculating and storing in advance a KNN graph containing for each object its W nearest neighbors (More information on KNN graph may be found in the Wikipedia article ‘Nearest neighbor graph’ found at https://en.wikipedia.org/wiki/ Nearest_neighbor_graph). The first KNN search operation performed on the reduced dimension vectors on the APU may find a smaller number K_{graph} of neighbors and the host processor may use the KNN graph to get additional neighbors and increase the number of objects needed for the second KNN search operation in the re-rank step to keep the needed accuracy.

When using a KNN graph, the number K_{graph} of reduced dimension vectors to be found can be reduced by at least the order of magnitude of W while maintaining the accuracy of the result. It may be noted that K_{graph} << K_{rdv} and W may be relatively small (e.g., 10). For example, for K_{graph} = 100 and W = 10, the number of I/O operations will be 100 while the number of objects available to host 15 for the re-rank operation will be 100 * (10 + 1) = 1100. By repeatedly using the KNN graph N times, each time for the additional W neighbors, the number of objects available to host 15 for the re-rank operation may be increased exponentially to W^{N}_{,} while keeping the number of I/O operations K_{graph} small.

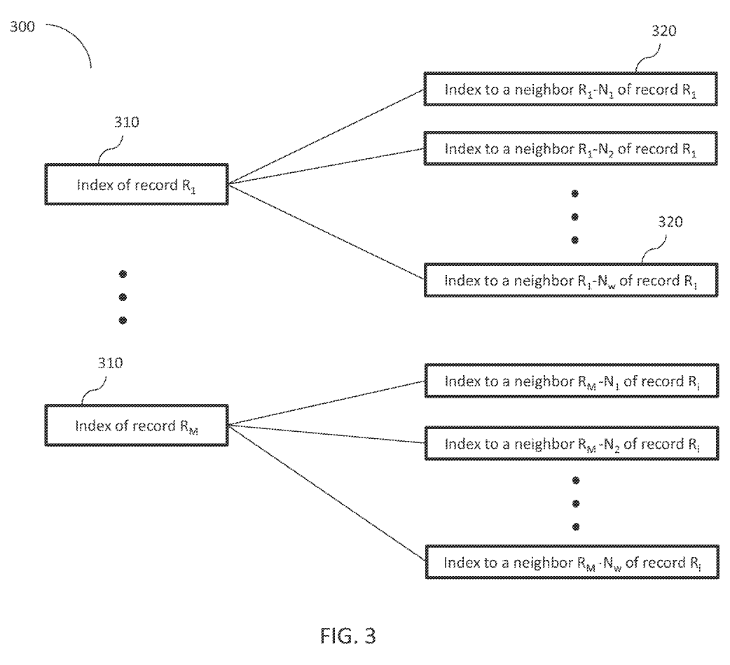

FIG. 3, to which reference is now made, is a schematic illustration of a KNN graph 300, calculated and stored in advance in accordance with an embodiment of the present invention. KNN graph may have several levels of nodes, where each level comprises indices to full dimension vectors stored in database 16. The first level of KNN graph 300 comprises M nodes 310 (M is the number of elements in database 16), and each node 310 comprises an index Ri to a full dimension vector stored in database 16 and W pointers to second level nodes 320. Each second level node 320 comprises an index Ri-Nj to a full dimension vector that is a neighbor of Ri.

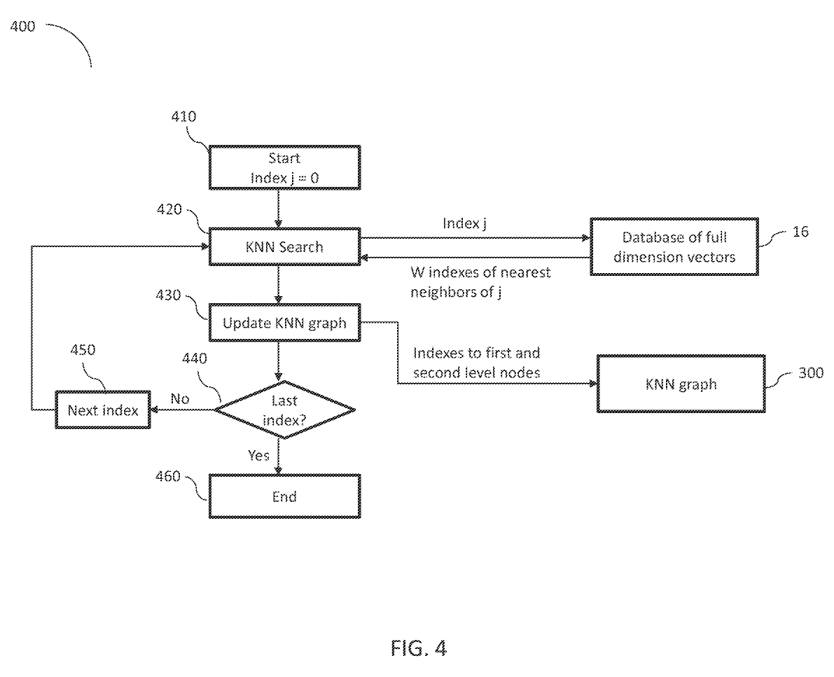

FIG. 4, to which reference is now made, is a schematic illustration of a flow implemented by a KNN graph determiner 400 responsible to create KNN graph 300 in advance. KNN graph determiner 400 may perform a KNN search for each record in full dimension vector database 16 and find its W nearest neighbors. KNN graph determiner 400 may create a graph listing for each object in the full dimension database 16 its index and the indices of its W nearest neighbors.

In step 410, KNN graph determiner may initiate the first index j of a full dimension vector stored in database 16 to 0. In step 420, KNN graph determiner 400 may perform a KNN search to locate the indexes of the W nearest neighbors of full dimension vector with index j. In step 430, KNN graph determiner 400 may update KNN graph 300 and create a node 310 with index j, and W nodes 320, each with the index of one of the located W nearest neighbors. In step 440, KNN graph determiner 400 may check if the last full dimension vector of database 16 has been handled and if not advance to the next index in step 450 and return to step 420 to create the nodes for the next object in database 16. If the last object has been handled, KNN graph determiner 400 may conclude its operation in step 460. The created KNN graph 300 includes for each object stored in database 16 its index and additional W indexes of its W nearest neighbors.

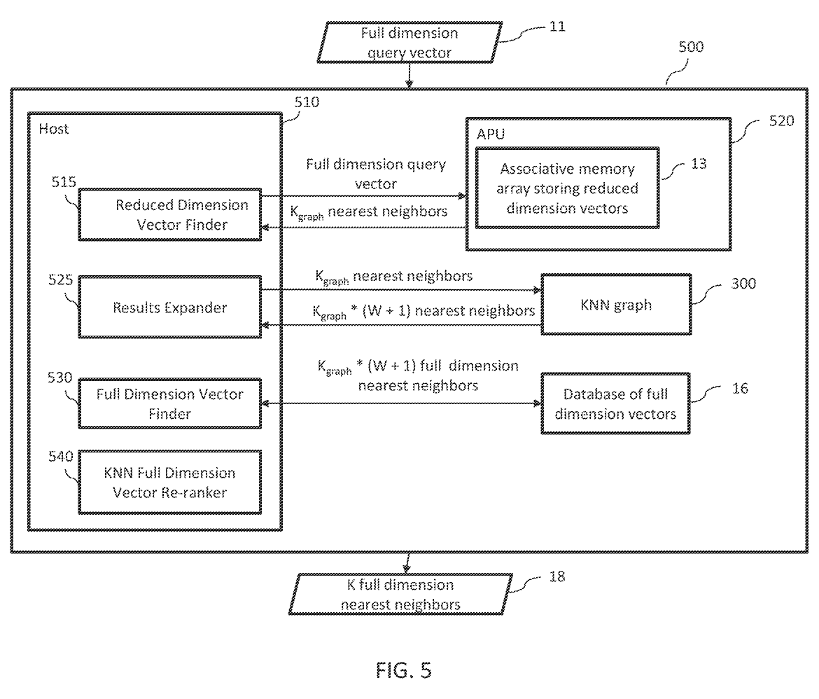

FIG. 5, to which reference is now made, is a schematic illustration of associative graph search system 500 constructed and implemented in accordance with an embodiment of the present invention. System 500 comprises a host 510, an APU 520, KNN graph 300 and database 16 of full dimension vectors.

APU 520 comprises an associative memory array 13 that may receive full dimension query vector 11, reduce its dimensions, perform a KNN search algorithm on a dataset of reduced dimension vectors and provide a predetermined number of nearest neighbors of query vector 11 in a very fast and constant complexity regardless of the number of neighbors.

Host 510 comprises a reduced dimension vector finder 515, a results expander 525, a full dimension vector finder 530 and a KNN full dimension vector re-ranker 540. Host 510 is in communication with APU 520, KNN graph 300 and database 16 of full dimension vectors.

Reduced dimension vector finder 515 may use APU 520 to find a relatively small number (K_{graph}) of nearest neighbors. Results expander 525 may use KNN graph 300 to expand the number of neighbors (to maintain the accuracy of the entire computation). Results expander 525 may use graph 300 to locate the relatively small number of nearest neighbors in first level nodes 310 and provide their W neighbors from their associated second level nodes 320 and expand the number of vectors available to host 510 from K_{graph} to K_{graph} * (W+1).

Results expander 525 may repeat its operation and expand the number of vectors again and again by locating the available vectors in first level nodes 310 and provide the W neighbors of each until the number of vectors available to host 510 is sufficient for the re-rank operation.

Full dimension vector finder 530 may fetch full dimension vectors associated with the available indexes from database 16 and KNN full dimension vector re-ranker 540 may perform a KNN search algorithm to find the final K nearest neighbors of vector 11 out of the available full dimension vectors.

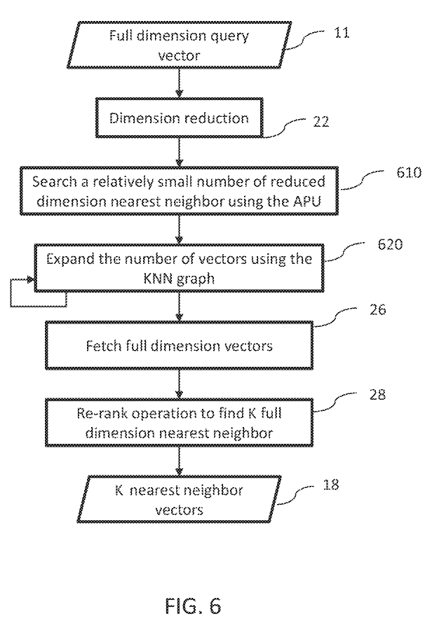

FIG. 6, to which reference is now made, is a schematic illustration of a flow that may be implemented by associative graph search system 500. The input to the flow is a full dimension query vector 11. System 500 may, in step 22, reduce the dimension of full dimension query vector 11 and, in step 610, activate a first KNN search algorithm to find a relatively small number (K_{rdv}) of reduced dimension nearest neighbors and provide their indices. In step 620, associative graph search system 500 may expand the relatively small number of vectors by using KNN graph 300 to bring for each vector its W neighbors. System 500 may repeat step 620 and expand the number of vectors until the number is sufficient.

In step 26, host 510 may fetch the expanded number of full dimension vectors from database 16 and in step 28 activate a second KNN search algorithm to re-rank the results and find the final K full dimension nearest neighbor and provide them as output 18.

It may be noted that using associative graph search system 500 may enable using much smaller dimension vectors to be searched in the KNN search step 610 since the number of neighbors can be expanded in host 510 using the KNN graph that provides additional neighbors to each vector found during the KNN search step. The overall operation of associative graph search system 500 may be much faster, since APU 520 may output far fewer results and KNN graph 300 may compensate by expanding the number of neighbors provided by APU 520.

It may be appreciated that the steps shown for the flows herein above are not intended to be limiting and that each flow may be practiced with variations. These variations may include more steps, less steps, changing the sequence of steps, skipping steps, among other variations which may be evident to one skilled in the art.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for determining a K-Nearest Neighbor (KNN) graph for a dataset of full dimension vectors, the method comprising:
for each record in a database of full dimension vectors:
performing a K-Nearest Neighbor (KNN) search to locate W nearest neighbors of said record; and
updating a KNN graph to include an index of said record and W indices of the W nearest neighbors located for said record;
wherein said updating comprises:
creating a first node for said record, said first node comprising an index of said record; and
creating W second-level nodes, each second-level node comprising an index of one of the W nearest neighbors.

2. A K-Nearest Neighbor (KNN) graph stored in a memory, the KNN graph comprising:
a plurality of first-level nodes, each first-level node corresponding to an item in a dataset, wherein each first-level node comprises:
an index to a full dimension vector of the corresponding item;
a plurality of second-level nodes; and
W pointers from a first-level node to a plurality of second-level nodes;
wherein each second-level node comprises an index to a full dimension vector that is a neighbor of the item corresponding to the first-level node from which the second-level node is pointed.
